(19) United States
(12) Patent Application Publication
(10) Pub. No.: US 2003/0208750 A1
(43) Pub. Date: Nov. 6, 2003

(54) Information exchange for process pair replacement in a cluster environment

(76) Inventors: Gunnar D. Tapper, Woodland Park, CO (US); Robert L. Jardine, Cupertino, CA (US); Gary S. Smith, Auburn, CA (US)

Correspondence Address: Hewlett-Packard Company, Intellectual Property Administration, Attn: Bill Streeter, P.O. Box 272400, Fort Collins, CO, 80527-2400, US

(21) Appl. No.: 10/112,263

(22) Filed: Mar. 29, 2002

(51) Int. Cl. G06F 9/445; G06F 15/177

(52) U.S. Cl. 717/177; 709/221

(57) ABSTRACT

A redundant system includes a primary process and a backup process. The system is configured to conduct online software replacement by sending an instruction to the backup process to terminate, and then starting a replacement backup process using an updated code version. Tokenized checkpoints are provided to the replacement backup process from the primary process, the tokenized checkpoints including a basic data structure and a token data structure. The token data structure includes one or more tokens that may be considered or may be ignored by the replacement backup process. After the state of the replacement backup process has been established, the replacement backup process is designated to be the new primary process. At that time, a new backup process is started using the updated code.

### BACKGROUND OF THE INVENTION

The present invention relates generally to software replacement in fault-tolerant data-processing architectures that use primary and backup processes to continue operation in the face of failure of a process or a processor in which a process is running.

Today's computing industry includes the concept of continuous availability, promising a processing environment can be ready for use 24 hours a day, 7 days a week, 365 days a year. This promise is based upon a variety of fault-tolerant architectures and techniques, among them being the clustered multiprocessor architectures and paradigms described in U.S. Pat. Nos. 4,817,091 and 5,751,932 to detect and continue in the face of errors or failures, or to quickly halt operation before the error can spread.

The quest for enhanced fault-tolerant environments has resulted in the development of the “process pair” technique—described in both of the above identified patents. Briefly, according to this technique, application software (“process”) may run on the multiple processor system (“cluster”) under the operating system as “process-pairs” that include a primary process and a backup process. The primary process runs on one of the processors of the cluster while the backup process runs on a different processor, and together they introduce a level of fault-tolerance into the execution of an application program. Instead of running as a single process, the program runs as two processes, one in each of two different processors of the cluster. If one of the processes or processors fails for any reason, the second process continues execution with little or no noticeable interruption of service. At this time, a new backup process can be created from the old backup process (which is now the new primary process), to recreate the process pair.

The backup process may be active or passive. If active, it will actively participate in receiving and processing periodic updates to its state in response to checkpoint messages from the corresponding primary process of the pair. If passive, the backup process may do nothing more than receive the updates, and see that they are stored in locations that match the locations used by the primary process. The content of a checkpoint message can take the form of complete state update, or one that communicates only the changes from the previous checkpoint message. Whatever method is used to keep the backup up-to-date with its primary, the result should be the same so that in the event the backup is called upon to take over operation in place of the primary, it can do so from the last checkpoint before the primary failed or was lost.

A challenge to the uninterrupted use of process pairs is the question of software replacement. What happens when a new version of the process software, or an updated version, is to replace the existing version? Preferably, updating should be done online, so that the functionality of the process pair continues uninterrupted during the software replacement. This is known as process pair replacement (PPR). One of the major problems with the PPR-based OSR (online software replacement) is that it is very hard to implement support for new or changed functions while ensuring that the checkpoint data structures remain compatible with earlier versions. If compatibility cannot be retained, then OSR cannot be performed; that is, the process pair must be taken out of service to be updated.

### SUMMARY OF THE INVENTION

According to one aspect of the invention, provided is a method of conducting online software replacement in a system including a primary process and a backup process, comprising the steps of:

sending an instruction to the backup process to terminate;

starting a replacement backup process using an updated code version;

providing tokenized checkpoints to the replacement backup process from the primary process, the tokenized checkpoints including a basic data structure and a token data structure, the token data structure including one or more tokens that may be considered or may be ignored by the replacement backup process; and

designating the replacement backup process to be a new primary process after the tokenized checkpoints have been received.

The method may further comprise:

operating the primary process as a backup process after designating the replacement backup process to be the new primary process;

terminating operation of the primary process as a backup process;

starting a new backup process using the updated code version; and

providing tokenized checkpoints to the new backup process from the new primary process to complete the online software replacement.

In one embodiment, the method further comprises:

operating the new primary process and the new backup process using non-tokenized checkpoints after the new backup process has been started.

In another embodiment, the method further comprises:

operating the new primary process and the new backup process using tokenized checkpoints after the new backup process has been started.

Further, the method may further comprise:

extracting tokens serially from tokenized checkpoints received by the replacement backup process, to locate tokens that can be utilized by the replacement backup process.

Still further, the method may further comprise:

scanning a data buffer for specific tokens in tokenized checkpoints received by the replacement backup process.

The method may also further comprise:

operating the primary process as a backup process, the primary process receiving tokenized checkpoints from the new primary process.

In such a case, the method may further comprise:

extracting tokens serially from tokenized checkpoints received by the primary process from the new primary process, to locate tokens that can be utilized by the primary process.

Alternatively, the method may further comprise:

scanning a data buffer for specific tokens in tokenized checkpoints received by the primary process from the new primary process.

According to another aspect of the invention, provided is a system including a primary process and a backup process, the system being configured to conduct online software replacement by:

sending an instruction to the backup process to terminate;

starting a replacement backup process using an updated code version;

providing tokenized checkpoints to the replacement backup process from the primary process, the tokenized checkpoints including a basic data structure and a token data structure, the token data structure including one or more tokens that may be considered or may be ignored by the replacement backup process; and

designating the replacement backup process to be the new primary process after the tokenized checkpoints have been received.

The system is may further be configured to:

operate the primary process as a backup process after designating the replacement backup process to be the new primary process;

terminate operation of the primary process as a backup process;

start a new backup process using the updated code version; and

provide tokenized checkpoints to the new backup process from the new primary process to complete the online software replacement.

The system is may further be configured to:

operate the new primary process and the new backup process using non-tokenized checkpoints after the new backup process has been started.

Still further, the system may be configured to:

operate the new primary process and the new backup process using tokenized checkpoints after the new backup process has been started.

Still further, the system may be configured to:

extract tokens serially from tokenized checkpoints received by the replacement backup process, to locate tokens that can be utilized by the replacement backup process.

The system may further be configured to:

scan a data buffer for specific tokens in tokenized checkpoints received by the replacement backup process.

The system may also further be configured to:

operate the primary process as a backup process, the primary process receiving tokenized checkpoints from the new primary process.

In such a case, the system may further be configured to:

extract tokens serially from tokenized checkpoints received by the primary process from the new primary process, to locate tokens that can be utilized by the primary process.

Alternatively, the system may further be configured to:

scan a data buffer for specific tokens in tokenized checkpoints received by the primary process from the new primary process.

According to another aspect of the invention, provided is a method of conducting online software replacement of an old-code version original process with an updated-code version replacement process, comprising the steps of:

receiving one or more tokenized checkpoints from the original process by the replacement process, the tokenized checkpoints including a basic data structure and a token data structure, the token data structure including one or more tokens;

scanning the tokenized checkpoints to determine tokens that are relevant to the replacement process;

updating the state of the replacement process using the data in the basic data structure and the tokens that have been determined to be relevant.

Further aspects of the invention will be apparent from the Detailed Description of the Drawings.

### BRIEF DESCRIPTION OF THE DRAWINGS

The accompanying drawings, which are incorporated in and constitute a part of this specification, illustrate several embodiments of the invention and together with the description, serve to explain the principles of the invention. Wherever convenient, the same reference numbers will be used throughout the drawings to refer to the same or like elements.

FIG. 1 is a schematic diagram showing a System Area Network embodying the invention;

FIG. 2 is a schematic diagram showing process pairs embodied in two multi-processor systems of the System Area Network of FIG. 1;

FIG. 3 is a timing diagram showing online software replacement (OSR) in the process pairs of FIG. 2; and

FIG. 4 is an illustration of a tokenized checkpoint used for OSR; and

FIG. 5 is an illustration of a token used in a tokenized checkpoint.

### DETAILED DESCRIPTION OF THE INVENTION

To enable one of ordinary skill in the art to make and use the invention, the description of the invention is presented herein in the context of a patent application and its requirements. Although the invention will be described in accordance with the shown embodiments, one of ordinary skill in the art will readily recognize that there could be variations to the embodiments and those variations would be within the scope and spirit of the invention.

The invention is typically embodied in a high-speed inter-processor communication system. In one embodiment of the invention, the high speed interprocessor communication is provided by means of a System Area Network (SAN). One example of a System Area Network (SAN) is that proposed by the Infiniband™ (IB) Trade Association. The IB SAN is used for connecting multiple, independent processor platforms (i.e., host-processor nodes), input/output (I/O) platforms, and I/O devices. The IB SAN supports both I/O and interprocessor communications for one or more computer systems. An IB system can range from a small server with one processor and a few I/O devices, to a parallel installation with hundreds of processors and thousands of I/O devices. Furthermore, the IB SAN allows bridging to an Internet, intranet, or connection to remote computer systems. IB provides a switched communications fabric allowing many devices to concurrently communicate with high bandwidth and low latency. An end node can communicate over multiple IB ports and can utilize multiple paths through the IB fabric. The multiplicity of IB ports and paths through the network are exploited for both fault tolerance and increased data-transfer bandwidth. IB hardware off-loads from the instruction-processing unit much of overhead associated with the I/O communications operation.

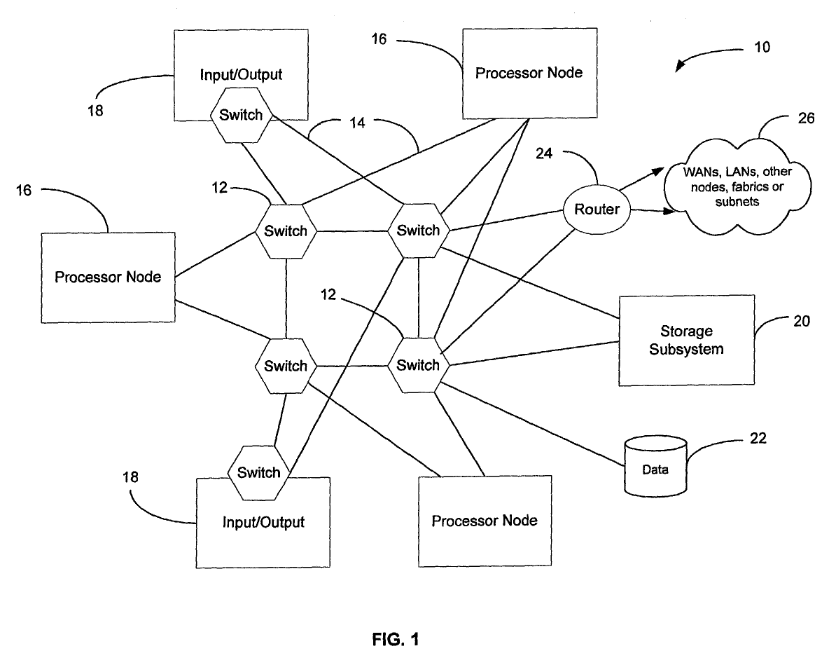

Referring now to the figures, and in particular FIG. 1, shown is a System Area Network (SAN) 10 incorporating the invention. The SAN 10 comprises a switch fabric and a number of nodes interconnected by the switch fabric. The switch fabric is generally accepted to be the switches 12 and the interconnecting links 14, while the nodes can, for example, include processor nodes 16, I/O nodes 18, storage subsystems 20 (e.g., a redundant array of independent disk (RAID) system) or a storage device such as a hard drive 22. The switch fabric may also include routers 24 to provide a link to other wide- or local-area networks, other nodes, fabrics, or subnets 26. When the SAN 10 forms part of a number of interconnected SANs, it is typically referred to as a subnet. The SAN nodes may attach to a single or multiple switches 12 and/or directly to one another. Well known examples of SANs include that proposed by the Infiniband™ (IB) Trade Association as mentioned above, as well as the ServerNet™ processor and I/O interconnect by Compaq Computer Corporation. It should be noted however that, while the invention is described herein with reference to a SAN architecture, any appropriate means of providing interprocessor communications may be used in the invention, for example, a dedicated high-speed interprocessor bus may be used.

As mentioned above, the invention relates to process pair replacement (PPR), additional details of which can be found in U.S. patent application Ser. No. 09/206,504 filed on Dec. 7, 1998 entitled “On-Line Replacement Of Process Pairs In A Clustered Processor Architecture,” the disclosure of which is incorporated herein by reference as if explicitly set forth.

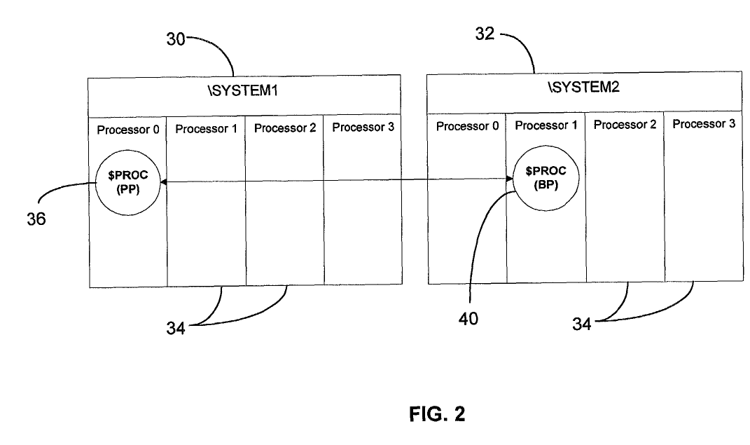

Turning now to FIG. 2, shown is a primary system 30 and a backup system 32. The systems 30, 32 each correspond to a processor node 16 in FIG. 1, and each comprise of a plurality of processors (instruction-processing units) 34. The primary system 30 has a primary process 36 running on processor 0, while the backup system 32 has a corresponding backup process 40 running on processor 1. The individual processors 34 within the two systems 30, 32 may be interconnected to each other by a SAN, similar to the SAN that connects the two systems, or by a high-speed interprocessor bus, or even by a shared memory subsystem.

Note however that primary system 30 and backup system 32 have only been designated as such with reference to the illustrated processes, and for ease of understanding. Primary system 30 and backup system 32 may have their roles reversed, or be completely unrelated, with reference to other processes running thereon. Also, while the primary and backup processes 36, 40 may be in two different systems (as shown in FIG. 2), they may also be in the same system.

Upon startup, primary process 36 creates backup process 40. The backup process 40 is a duplicate of the primary process 36, and is intended to provide fault-tolerant processing. This fault-tolerant processing is provided by means of redundancy, that is, if primary process 36 should fail, if processor 0 should fail, or if the primary system 30 should fail, backup process 40 is available to continue the work being performed by the primary process PP 36. In order to keep backup process 40 up-to-date with primary process PP 36 as its processing continues, it is necessary to provide checkpoint information to backup process 40 in a known manner, as modified below. The checkpoint information provided includes tokenized checkpoints as described in more detail below.

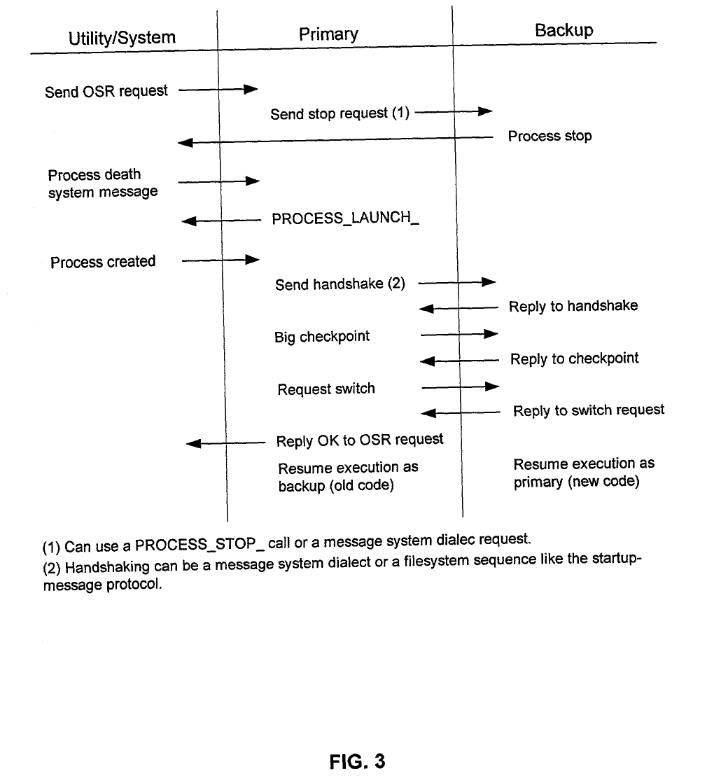

FIG. 3 shows an exemplary timing chart for OSR. When it is desired to update the software for a process pair, the following steps are taken:

1. OSR is triggered by an operator command. One of the attributes of this command is the name of the object file to be used in the OSR.

2. After validation of the object file (for example, the primary process makes sure that the object file is of the correct type and a version of the same program), the primary process stops the backup process.

3. A backup-process-death message is sent to the primary process.

4. The primary process launches a new backup process, using the replacement object file.

5. Once the replacement backup process has been created, the primary process sends a handshake message to the backup process, initiating a version exchange to ensure that the two processes can communicate. If the two processes can communicate, the primary process may also determine what message format to use in the communication; that is, the layout of the checkpoint messages. The determination of what message format to use is typically not required using the tokenized checkpoint messages of the invention, described in more detail below. By using tokenized checkpoints, both the primary process and the replacement backup process have been coded to recognize a tokenized checkpoint including a defined basic data structure and a token data area. The basic data structure includes required data, and the token data area includes tokenized data that may or may not be considered by the receiving process.

6. After the two processes have agreed that they can communicate, the primary process sends all information needed to establish the state of the backup process. This is referred to as a “big checkpoint” in FIG. 3, but it can be several checkpoint messages in reality. The sent checkpoints are tokenized checkpoints as described in more detail below.

7. Once all the necessary information has been checkpointed, the primary process sends a message to the backup process telling it to switch roles with the primary process.

8. The switch occurs, making the replacement backup process the primary process of the process pair and making the original primary process the backup process. Therefore, from now on, the main tasks of the process pair are processed by the new code, including, for example, handling incoming requests (messages) from the rest of the SAN 10 or from outside the SAN 10.

9. Finally, steps 1 to 6 of the above process are repeated to replace the “old code” backup process (formerly the primary process) with a “new code” backup process, thereby completing the online-software replacement, and establishment of a “new code” process pair. The establishment of the new code backup process could also be automatic, thus avoiding step 1, the operator initiation of the establishment of the “new code” backup process. For example, the new code, now acting as the primary at this point, could be programmed to initiate an auto-replacement of the “old code backup” either after some period of time or after some number of successful checkpoints have been processed, or after some other such criterion, is met.

One of the challenges previously facing PPR-based OSR is that it is difficult to implement support for new or changed functions while ensuring that the checkpoint data structures remain compatible with earlier versions. If compatibility cannot be retained, then OSR cannot be performed; that is, the process pair must be taken out of service to be updated.

The invention alleviates the problem of compatibility between software versions by providing tokenized checkpoints, an example of which is shown in FIG. 4, generally indicated by the numeral 50. Tokenized checkpoints contain self-identifying data items including an identifying number, the data type of the data item's value, the length of the value, and the value itself.

As can be seen from FIG. 4, the tokenized checkpoint 50 consists of four pieces, a version field 52, a length field 54, a version-specific basic data structure 56, and a token data area 58, which can contain any number of tokens 60 of different lengths.

The version field 52 is provided even though the primary and backup processes have agreed how to communicate with each other as part of the PPR handshake. It is good practice, although not required, to include the version field 52, which indicates what version of the checkpoint data structure is being used. For example, the version field provides for easier debugging and allows the consumer of the checkpoint data structure the option of double-checking that the correct format is being used on a per-message basis. While the use of a version field 52 is preferred, as an alternative the processes 36, 40 may decide which version to use during the PPR handshake as discussed above.

The length field 54 indicates the total length of the tokenized checkpoint, including the version and length fields.

The basic data structure 56 of the tokenized checkpoint 50 contains data items that rarely change. Thus, part of the PPR handshake is to determine that the involved processes know about the version of the basic data structure 56 being used. How to define “rarely change” will clearly be software-specific, but two reasonable expectations are that:

1. The basic data structure 56 changes no more frequently than product (i.e., software) versions are created. “Product version change” in this context refers to a major change, which occurs infrequently.

2. The basic data structure 56 remains intact when implementing changes for product version updates. Product version updates are typically planned product maintenance and time-critical fixes.

As the structure of the basic data structure 56 changes with new versions of the tokenized checkpoint 50, a minimum backward compatibility is required for the basic data structure 56. At a minimum, any version of the software should be able to create and process a basic data structure 56 that is one revision old. If feasible, software designers may consider supporting two versions' difference for the basic data structure 56; that is, the current version, the previous version, and the current version minus two versions.

One way of ensuring this compatibility is to allocate a known space of the tokenized checkpoint 50 for the basic data structure 56, then use overlays to map one version of the basic data structure 56 to the basic data structure 56 version that can be understood by the older process of the process pair. The basic data structure 56 should also contain a length field. As mentioned above, the version field 52 (that will change when the basic data structure is updated) helps the consumer of the basic data structure 56 to determine which data structure to use for the overlay.

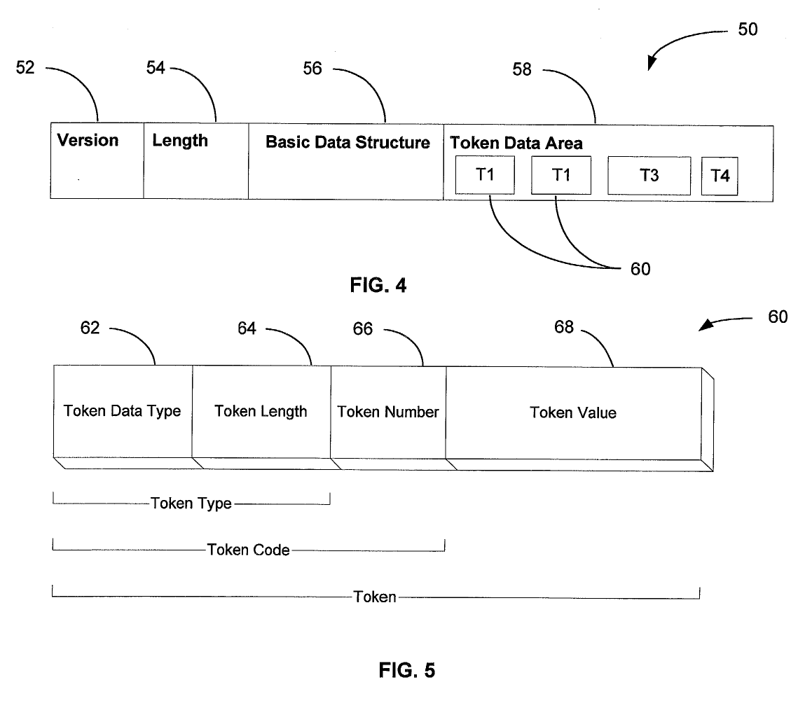

The token data area 58 helps achieve overall compatibility—the process creating the tokenized checkpoint 50 does not need to be concerned about whether the consumer of the data can use all tokens 60. Tokens 60 are self-describing data items; a typical token 60, shown in FIG. 5, carries with it the data type of its value, the length of its value, an identifying number, and the value.

A token 60, shown in FIG. 5, may be viewed as consisting of two parts: a token code and a token value. The token code consists of the token data type 62, token length 64, and a token number 66. The token data type 62 and token length 64 are known collectively as the token type. The token data type 62 is the fundamental data type of the token's value, represented as an enumeration. The token length 64 is the length of the token value in bytes. The token number 66 is a number that uniquely identifies that token within the set of tokens defined by the software designer. Token numbers may be integers, for example.

The tokens may be of two different token data types—simple tokens, or extensible data tokens. Simple tokens are those whose values are elementary data items or fixed structures. Extensible data tokens are those whose values are contained in structures that can be extended by adding fields to the ends of the structures. Associated with the extensible data structure is a token map, which contains the null value (discussed in more detail below) and version for each field in the structure and is used to initialize the extensible data structure before it's used.

Tokenized checkpoints are preferably, but not necessarily, limited to simple tokens only, since the use of extensible data structures may cause too much of a performance impact.

Three basic techniques should be used when programming for a tokenized data area:

1. Tokens can never be moved or removed from the token data area 58 by any process.

2. Each process looks for the tokens that are relevant to it, and ignores the rest.

3. Every token should have at least one value defined as “invalid.”

The first compatibility rule states that tokens cannot be removed from the token data area 58. However, given that the tokenized checkpoint 50 and therefore the token data area 58 can be only so large, this rule might be unreasonable for OSR. For OSR, a token may eventually be “promoted” to be part of the basic data structure 56, thereby justifying its removal from the token data area 58. Great care has to be taken when this is done; a token 60 can be removed only when all supported versions understand the new basic data structure 56. Therefore, some versions of the tokenized checkpoint 50 will require the token to be both part of the token data area 58 and integrated into the basic data structure 56.

The second compatibility rule is an expression of the general principle embodied in the token concept. Consider an old-version process passing tokenized checkpoints to a new version process during initialization of the new-version process after OSR. The tokenized checkpoints from the old-version process may include tokens 60 that related to discontinued functionality in the new-version process. The new-version process can ignore these tokens. Further, tokenized checkpoints by the new version process will in all likelihood include additional tokens relating to new functionality. While such tokens will of course not be present in the tokenized checkpoints received from the old-version process, the new-version process will include checkpoints that have tokens reflecting the new functionality, which will be utilized after OSR by the “new code” backup process. The process receiving the tokens may use any method to determine tokens that are relevant. For example, the process may extract data tokens serially, discarding tokens that it does not recognize or cannot use. Depending on how many tokens there are that need to be extracted, this may or may not help improve performance. In some cases, it may be faster for a process to scan the data buffer for specific tokens, since the process might then find the tokens it is looking for earlier. Tokens that can be used or ignored are typically identified using the token number.

The third rule refers to initializing each token with an invalid value, which is sometimes referred to as a “null value.” This is done to allow the consumer of the token to determine whether the sender assigned a value to that token or, more commonly, to a specific field in an extensible data structure. If the field contains the invalid value, the sender did not assign a value to that field, which means that its contents can be ignored. (Unless a value is required in the field, which would mean that the sender did not fill in the data structure properly.)

When the OSR process is completed, with new-code versions of both the primary process and the backup processes running, the checkpoints that are passed between the processes may revert to being conventional checkpoint messages. That is, in one embodiment, the processes may continue to use tokenized checkpoints during normal operation, but in another embodiment, the tokenized checkpoints are not used during normal operation. That is, there may be a performance benefit to using conventional checkpoint messages during normal operation.

It can be noted that there may be less utility in the use of tokenized checkpoints in the intermediate stage of PPR when the primary process is the old code version and the backup process is the new code version. This is because the new code version can always be programmed to handle any version of checkpoint message from the old code version, since all of the older code versions are (presumably) known to the programmer of the new code version. However, when the newer version becomes the primary and starts sending checkpoints to the older version, the utility of the tokenized checkpoints is readily apparent, because (previously) the older version could not be programmed in advance to handle all future versions of checkpoint messages. However, the use of tokenized checkpoint messages throughout process pair replacement still provides a benefit, since a design that excludes knowledge of destination process code version for checkpoint handling reduces complexity and simplifies process code design.

Although the present invention has been described in accordance with the embodiments shown, variations to the embodiments would be apparent to those skilled in the art and those variations would be within the scope and spirit of the present invention. Accordingly, it is intended that the specification and embodiments shown be considered as exemplary only. For example, while the invention has been illustrated using a primary process and a single backup process, the invention could easily be adapted to redundant systems using multiple backups, or a system in which the process pair itself is duplicated to form a redundant “process quad” as described in U.S. patent application entitled USING PROCESS QUADS TO ENABLE CONTINUOUS SERVICES IN A CLUSTER ENVIRONMENT,” filed on Mar. 8, 2002, attorney docket no. 20206-143, the disclosure of which is incorporated herein as if explicitly set forth.

What is claimed is:

1. A method of conducting online software replacement in a system including a primary process and a backup process, comprising the steps of:
sending an instruction to the backup process to terminate;
starting a replacement backup process using an updated code version;
providing tokenized checkpoints to the replacement backup process from the primary process, the tokenized checkpoints including a basic data structure and a token data structure, the token data structure including one or more tokens that may be considered or may be ignored by the replacement backup process; and
designating the replacement backup process to be a new primary process after the tokenized checkpoints have been received.

2. The method of claim 1 further comprising:
starting a new backup process using the updated code version.

3. The method of claim 2 further comprising:
operating the new primary process and the new backup process using non-tokenized checkpoints after the new backup process has been started.

4. The method of claim 2 further comprising:
operating the new primary process and the new backup process using tokenized checkpoints after the new backup process has been started.

5. The method of claim 1 further comprising:
extracting tokens serially from tokenized checkpoints received by the replacement backup process, to locate tokens that can be utilized by the replacement backup process.

6. The method of claim 1 further comprising:
scanning a data buffer for specific tokens in tokenized checkpoints received by the replacement backup process.

7. The method of claim 1 further comprising:
operating the primary process as a backup process, the primary process receiving tokenized checkpoints from the new primary process.

8. The method of claim 7 further comprising:
extracting tokens serially from tokenized checkpoints received by the primary process from the new primary process, to locate tokens that can be utilized by the primary process.

9. The method of claim 7 further comprising:
scanning a data buffer for specific tokens in tokenized checkpoints received by the primary process from the new primary process.

10. A system including a primary process and a backup process, the system being configured to conduct online software replacement by:
sending an instruction to the backup process to terminate;
starting a replacement backup process using an updated code version;
providing tokenized checkpoints to the replacement backup process from the primary process, the tokenized checkpoints including a basic data structure and a token data structure, the token data structure including one or more tokens that may be considered or may be ignored by the replacement backup process; and
designating the replacement backup process to be a new primary process after the tokenized checkpoints have been received.

11. The system of claim 10 wherein the system is further configured to:
start a new backup process using the updated code version.

12. The system of claim 11 wherein the system is further configured to:
operate the new primary process and the new backup process using non-tokenized checkpoints after the new backup process has been started.

13. The system of claim 11 wherein the system is further configured to:
operate the new primary process and the new backup process using tokenized checkpoints after the new backup process has been started.

14. The system of claim 10 wherein the system is further configured to:
extract tokens serially from tokenized checkpoints received by the replacement backup process, to locate tokens that can be utilized by the replacement backup process.

15. The system of claim 10 wherein the system is further configured to:
scan a data buffer for specific tokens in tokenized checkpoints received by the replacement backup process.

16. The system of claim 10 wherein the system is further configured to:
operate the primary process as a backup process, the primary process receiving tokenized checkpoints from the new primary process.

17. The system of claim 16 wherein the system is further configured to:
extracting tokens serially from tokenized checkpoints received by the primary process from the new primary process, to locate tokens that can be utilized by the primary process.

18. The system of claim 16 wherein the system is further configured to:
scanning a data buffer for specific tokens in tokenized checkpoints received by the primary process from the new primary process.

19. A method of conducting online software replacement of an old-code version original process with an updated-code version replacement process, comprising the steps of:
receiving one or more tokenized checkpoints from the original process by the replacement process, the tokenized checkpoints including a basic data structure and a token data structure, the token data structure including one or more tokens;
scanning the tokenized checkpoints to determine tokens that are relevant to the replacement process;
updating a state of the replacement process using the data in the basic data structure and the tokens that have been determined to be relevant.
